(19) United States
(12) Patent Application Publication
(10) Pub. No.: US 2009/0037396 A1
(43) Pub. Date: Feb. 5, 2009

(54) SEARCH APPARATUS AND SEARCH METHOD

(75) Inventors: Naoya Uematsu, Takushima-shi (JP); Motohiko Mouri, Takushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 12/090,536

(22) PCT Filed: Oct. 18, 2006
(86) PCT No.: PCT/JP2006/320782

§ 371 Date: Aug. 13, 2008

(30) Foreign Application Priority Data
Oct. 18, 2005 (JP) 2005-303768

(51) Int. Cl. G06F 7/06; G06F 17/30

(52) U.S. Cl. 707/4; 707/E17.014; 707/E17.108

(57) ABSTRACT

A search technique having enhanced ease-of-use is provided. A search server analyzes web contents, extracts index information (e.g., time, geographical name, personal name, and business type), and registers the index information in an index information database. A time information search unit performs search using time as a key, a geographical name information search unit performs search using a geographical name as a key, a personal name information search unit performs search using a personal name as a key, a business type information search unit performs search using a business type as a key, and a topic information search unit performs search using a topic as a key. In order to perform narrowing down search while using these search engines integrally, a federated search unit provides a user interface to specify combined search conditions for the search engines.

### TECHNICAL FIELD

The present invention relates to search techniques, and particularly to apparatus and method to search for the information that matches the desired condition from the information accessible via a network.

### BACKGROUND ART

With the explosion of Internet use, there is a deluge of information on the web. In some search services for web contents, keywords are received and the web page which includes the keywords are then searched for; and in other search services, web pages are sorted into hierarchized categories. Also, new search services such as meta search engine have emerged which cross search a plurality of search engines.

### DISCLOSURE OF INVENTION

### Problems to be Solved by the Invention

While Internet users can access various kinds of information at any time, it has become a big challenge to search for the desired information from a multitude of information sources.

In this background, a general purpose of the present invention is to provide a search technique that enhances the ease-of-use.

### Means for Solving the Problems

A search apparatus according to an aspect of the present invention comprises: a user interface unit operative to provide an integrated user interface including a plurality of user interfaces to receive a search condition for a plurality of respective search units which perform search using a plurality of different information items as a key; a search result acquisition unit operative to notify respective search units of the plurality of search conditions received by the user interface unit and acquire a search result from the search units; and a presenting unit operative to present the search result which satisfies the plurality of search conditions.

The search apparatus may further comprise: an acquisition unit operative to acquire a content which acquires data via network; an analysis unit operative to analyze the acquired content, extract the information to be the key for the search, and register the information in a database; and the search unit may search for a content which matches the search condition by referring to the database.

Optional combinations of the aforementioned constituting elements, and implementations of the invention in the form of methods, apparatuses, and systems may also be practiced as additional modes of the present invention.

### ADVANTAGES

The present invention provides a search technique having the enhanced ease-of-use.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows a configuration of a search system according to the embodiment;

FIG. 2 is a diagram which shows the configuration of a search server according to the embodiment;

FIG. 3 is a diagram which shows an example of internal data of an index information database;

FIG. 4 is a diagram which shows an example of a user interface provided by a federated search unit; and

FIG. 5 is a diagram which shows an example of contents extracted during the search.

### REFERENCE NUMERALS

10 search system, 22 web server, 24 user terminal, 30 search server, 32 content acquisition unit, 34 content analysis unit, 35 dictionary storing unit, 36 registration unit, 38 index information database, 40 search unit, 41 time information search unit, 42 geographical name information search unit, 43 personal name information search unit, 44 business type information search unit, 45 topic information search unit, 50 federated search unit.

### BEST MODE FOR CARRYING OUT THE INVENTION

Suggested in the present embodiment is a search technique in which different information items are used as keys and the information can be narrowed down by applying the combination of a plurality of keys. Also, a UI to offer the aspect covering a plurality of search services integrated is prepared so that the technique to support the knowledge discovery of a user is suggested.

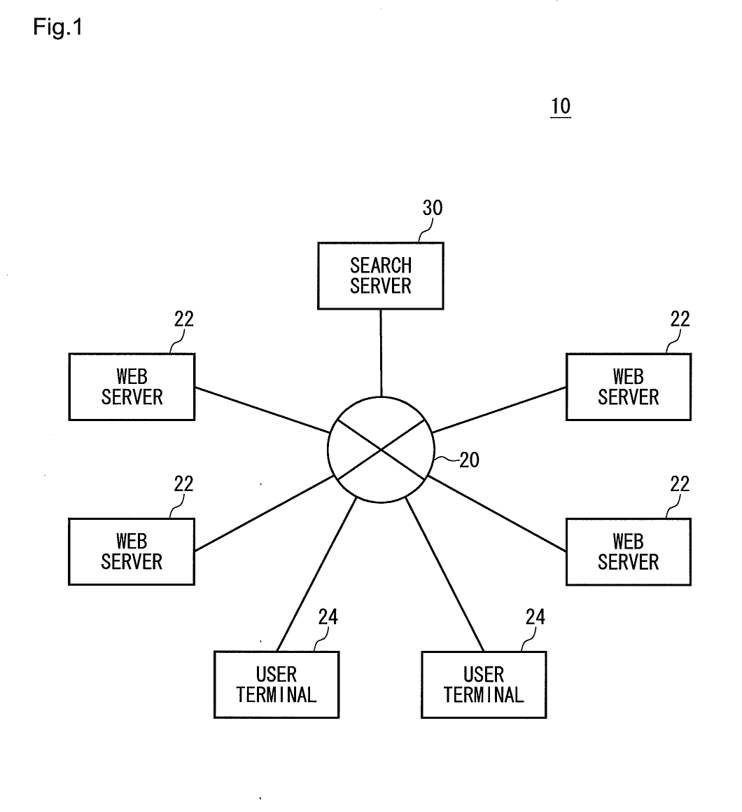

FIG. 1 shows the configuration of a search system 10 according to the embodiment. A search server 30, a web server 22, and a user terminal 24 are connected to internet 20 which is an example of a network. The search server 30 acquires web contents provided by the web server 22 from the web server 22, analyzes the details of the contents, creates the index information, and register the index information in a database. The user terminal 24 accesses the search server 30, indicates the search condition, and requests a search. Referring to the database, the search server 30 searches for the contents that match the condition indicated by the user, and presents to the user terminal 24 a list of URL of the contents that match the condition. By clicking a link to the desired contents in the list, the user can browse the desired contents.

The search server 30 offers a search service which enables the search using “time”, “address”, “personal name”, “business type”, and “telephone number” as keys. Each search engine offers UI for search which is easy to be manipulated intuitively in accordance with the attribute of the information that becomes a key. For example, the search engine which performs search using “time” as a key offers a UI including a calendar, a time slider and the like so as to receive the designation of time. The search engine which performs search using “address” as a key offers a UI including a map and the like so as to receive the designation of address.

The search server 30 offers an integrated UI so as to combine the search engines and narrow down the information. For example, the combined information such as “I want the information on the events which will take place in Tokyo next week.” can be dealt with. With this, the results from the various search engines can be compared from various aspects, and finding the information by the user can be supported efficiently. Thus, the ease-of-use for the user can be dramatically improved.

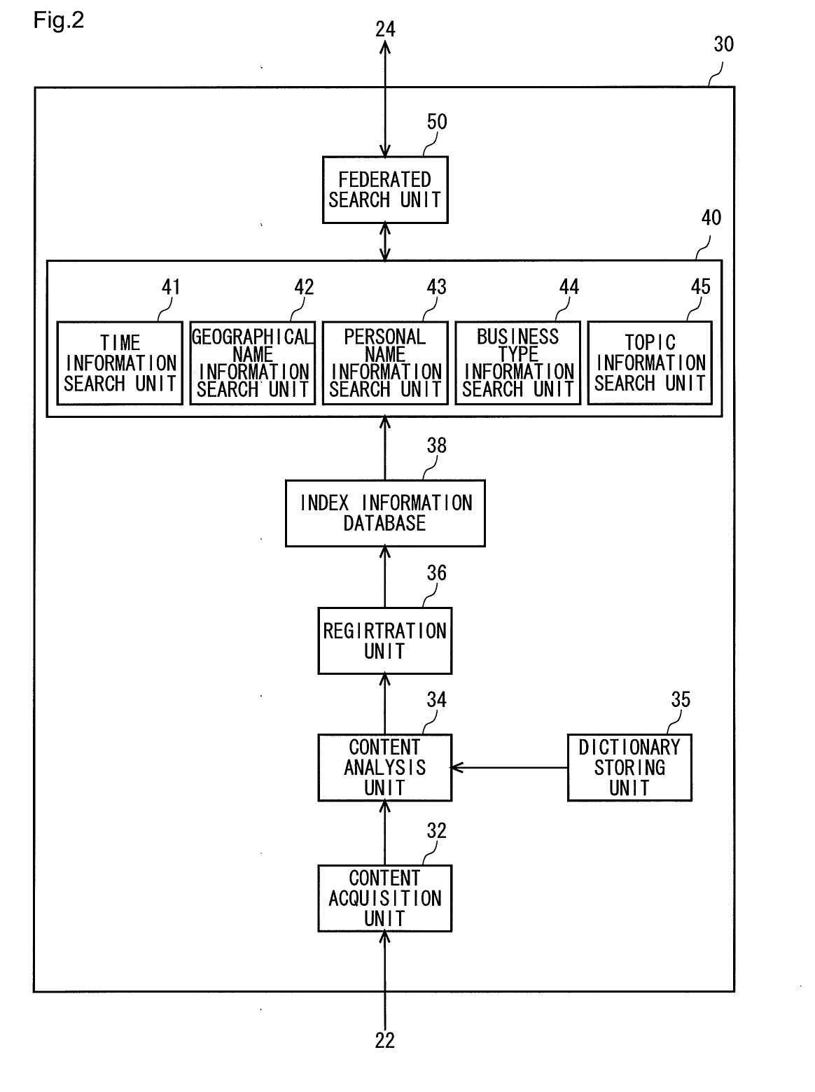

FIG. 2 shows the configuration of the search server 30. The search server 30 is provided with a content acquisition unit 32, a content analysis unit 34, a registration unit 36, an index information database 38, a search unit 40, and a federated search unit 50. These configurations are implemented in hardware component by any CPU of a computer, a memory or a program loaded into the memory. Functional blocks are implemented by the cooperation of hardware components. Thus, it should be understood by a person skilled in the art that these functional blocks can be realized in a variety of forms by hardware only, software only or the combination thereof.

The content acquisition unit 32 accesses the web server 22 via internet 20 and acquires the contents stored in the web server 22. When the search server 30 searches for the contents stored in, for example, a hard disk in the apparatus thereof in a stand-alone environment, the content acquisition unit 32 accesses the memory apparatus connected to the apparatus thereof and acquires the contents retained. The content analysis unit 34 analyzes the contents acquired by the content acquisition unit 32 and extracts the information to be a key for the search. The registration unit 36 registers in the index information database 38 the index information of the contents extracted by the content analysis unit 34.

The content analysis unit 34 extracts the information such as named entities (e.g., date, geographical name, name of things, telephone number, personal name, and business type) that are included in the web page by using name entity extraction technique, indexes the information, and then registers the information in the index information database 38. The content analysis unit 34 may break down the text information included in the web contents into morphemes using morphological analysis technique and extract the named entities from the noun morphemes which are broken down by referring to a dictionary stored in the dictionary storing unit 35. A thesaurus dictionary having information such as synonyms and antonyms, and an ontology dictionary having information indicating conceptual classification may be used at this time.

When extracting the time information from the contents, the content analysis unit 34 may supplement the time information by acquiring the information of a creation date and time and an update date and time of the contents. For example, if there is only date listed and no year is specified, the year when the contents are created may supplement the information. By analyzing, for example, the structure of the contents, the content analysis unit 34 may specify the effective range of the information such as time and address included in the contents. For example, if there is a web page such as “company profile” in the website of a company, it is conceivable that the information of the location included in the page indicates the address of the company. Thus, the web contents under the domain can be considered as a block and the location of the company may be associated with the web contents as the address information. For the web page including a list of restaurants, the correspondence of restaurant names and addresses may be analyzed based on the layout of, for example, a chart. Also, if there is a web page including links in a personal website, the content analysis unit 34 may extract the relation between personal names and associate with each other. The contents are systemized from a plurality of different standpoints by the foregoing technique.

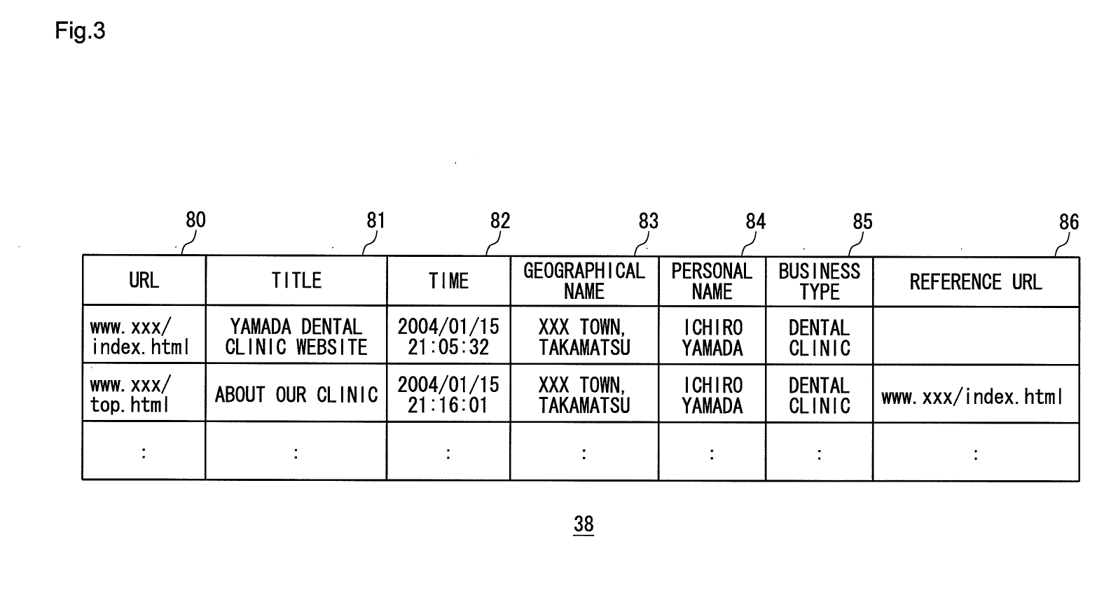

FIG. 3 shows the example of internal data of an index information database. The index information database 38 is provided with a URL column 80, a title column 81, a time column 82, geographical name column 83, a personal name column 84, a business type column 85, and a reference URL column 86. The URL column 80 stores URL of the contents of, for example, a web page. The title column 81 stores a title of the contents. The time column 82, the geographical name column 83, the personal name column 84, and the business type column 85 store the time information, the geographical name information, the personal information, and the business type information included in the contents extracted by the content analysis unit 34, respectively. As described above, indexing the information which is extracted permits the search to be realized in which different information items are used as keys. The reference URL column 86 stores URL of the related contents. The related contents may be the contents (e.g., destination contents linked to given contents or source contents linking itself with given contents) which have a reference relationship or may be the contents having a high degree of similarity between the contents. The relation between the contents may be constructed in accordance with the hierarchic structure of a folder in the web server 22, or in accordance with the relation between persons as described above. The index information database 38 may further store the information, for example, keywords included in the contents, creation dates and times of the contents, and update dates.

The search unit 40 receives the search condition and searches for the contents which match the condition by referring to the index information database 38. The search unit 40 includes a plurality of search engines to perform the search using a plurality of different information items as keys. The time information search unit 41 searches the index information database 38 using the time information as a key. The time information search unit 41 offers a screen based on a time axis (e.g., calendar or time slider) as a UI, maps the contents which includes time information to a screen including the calendar or the time slider, and allows the user to jump to the corresponding page by clicking the screen.

The geographical name information search unit 42 searches the index information database 38 using the information, for example, geographical names, latitudes and longitudes, as a key. The geographical name information search unit 42 offers the screen based on a map as a UI, and maps the contents which include a geographical name or spot information on a map. With this, the user can reach the information from the map browse.

The personal name information search unit 43 searches the index information database 38 using the personal name information as a key. The personal name information search unit 43 clusters and presents contents related to personal names. For example, the names of the people sharing the same name are classified and then presented. Upon the specification of a person, the personal name information search unit 43 makes the detailed information on the person (e.g., personal background and the latest information) available widely. Also, the personal relation may be presented.

The business type information search unit 44 searches the index information database 38 using the business type as a key. The business type information search unit 44 clusters and presents contents related to business types.

The topic information search unit 45 graphs the change in the amount of the topics, for example, by a week, and presents the history of the specified topic. For example, the details of the topics, the time when the topics came out, and the kind of people who are talking about the topics are presented to be seen.

As described above, since each search engine provides a user friendly and intuitive UI, the-ease-of-use for the user is enhanced.

The federated search unit 50 provides a user interface including a plurality of integrated user interfaces to receive search conditions respectively for a plurality of search engines. The respective search engines are then notified of the plurality of search conditions received by the interface, and the search is performed. Upon the acquisition of the search results, the federated search unit 50 presents the search results which satisfy the plurality of search conditions received from the user. With this, narrowing down search using a plurality of searches as keys can be performed.

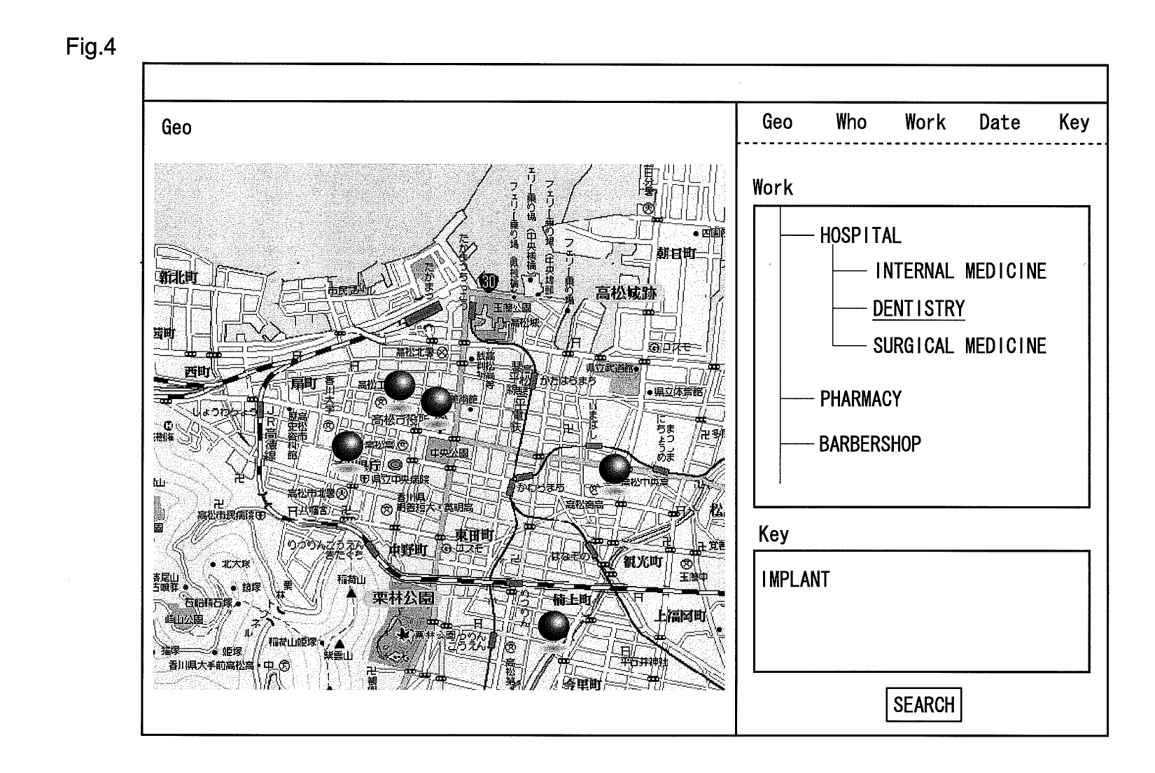

FIG. 4 shows the example of a user interface provided by a federated search unit 50. In the example of FIG. 4, the UI provided by the geographical name information search unit, the UI showing a tree of the business type classification provided by the business type information search unit, and the UI which receives keywords are integrally presented. When the user performs a search by inputting “implant” as a keyword while having the map of the Takamatsu and the surrounding areas displayed using the map UI, and selecting the Dentistry category in the tree of the business type classification, the search unit 40 extracts from the index information database 38 the contents which include “Takamatsu and the surrounding areas” as geographical information, the information classified “Dentistry” category as business type information, and “implant” as a keyword. When searching for the contents which include the geographical name information of “Takamatsu and the surrounding areas”, the geographical name information search unit 42 may extract not only the contents which include “Takamatsu” as geographical name information but also geographical names of the surrounding areas of Takamatsu by referring to, for example, a dictionary on the geographical names and search for the contents which include the extracted geographical names. Referring to the geographical name information of the extracted contents, the search unit 40 displays icons on the corresponding positions on the map. The user clicks the icon to jump to the contents.

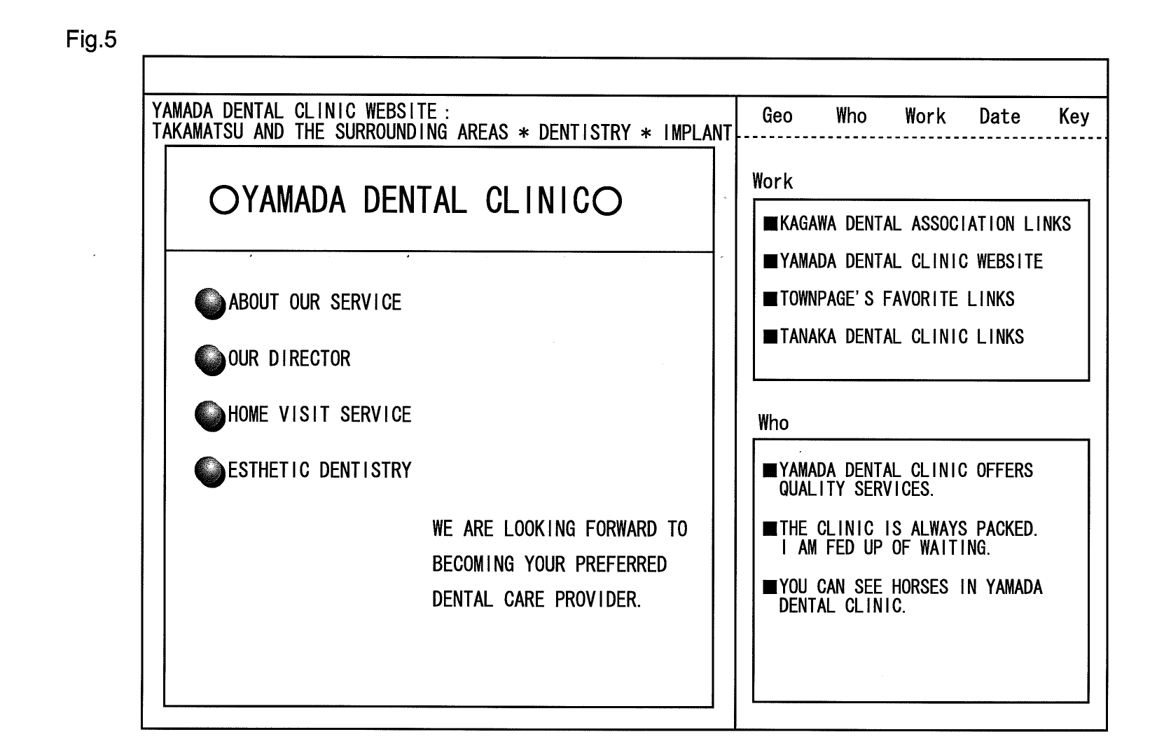

FIG. 5 shows an example of the contents extracted during the search. In this example, there are a plurality of the contents including the address of the position where the user has clicked and the contents are displayed in the upper right region of the screen. If the user selects “Yamada Dental Clinic Website” from the lists, the contents are displayed in the left region of the screen. Also, the contents which include “Yamada Dental Clinic” as personal name information are displayed in the lower right region of the screen as related information.

Described above is an explanation based on the embodiments of the present invention. These embodiments are intended to be illustrative only and it will be obvious to those skilled in the art that various modifications to constituting elements and processes could be developed and that such modifications are also within the scope of the present invention.

### INDUSTRIAL APPLICABILITY

The present invention provides a search technique having the enhanced ease-of-use.

1. A search apparatus comprising:
a user interface unit operative to provide an integrated user interface including a plurality of user interfaces to receive a search condition for a plurality of respective search units which perform search using a plurality of different information items as a key;
a search result acquisition unit operative to notify respective search units of the plurality of search conditions received by the user interface unit and acquire a search result from the search units; and
a presenting unit operative to present the search result which satisfies the plurality of search conditions.

2. The search apparatus according claim 1, further comprising:
an acquisition unit operative to acquire a content via network;
an analysis unit operative to analyze the acquired content, extract the information to be the key for the search, and register the information in a database; wherein
the search unit searches for a content which matches the search condition by referring to the database.

3. The search unit according to claim 2, wherein
the analysis unit extracts the information on any one of time, place, thing, person, and business included in the content by the extraction of the named entities, and registers the information in the database, and
the plurality of search units receive the respective search conditions on at least two pieces of information out of the information on time, place, thing, person, and business, and perform search by referring to the database.

4. The search apparatus according to claim 1, wherein a search unit which performs search by receiving a search condition on time displays a calendar or a time axis and provides a user interface to receive a search condition from a user.

5. The search apparatus according to claim 1, wherein a search unit which performs search by receiving a search condition on place displays a map and provides a user interface to receive a search condition from a user.

6. A search method comprising:
receiving a plurality of search conditions via an integrated user interface including a plurality of user interfaces to receive a search condition respectively for a plurality of search units which perform search using a plurality of different information as a key, notifying respective search units of the plurality of search conditions received, and acquiring a search result from the search unit; and
presenting a search result which satisfies the plurality of search conditions.

7. A computer program product comprising:
a module which provides an integrated user interface including a plurality of user interfaces to receive a search condition respectively for a plurality of search units which perform search using a plurality of different information items as a key;
a module which notifies respective search units of the plurality of search conditions received via a user interface unit and acquires a search result from the search units; and
a module which presents the search result which satisfies the plurality of search conditions.
